(19) United States
(12) Patent Application Publication
(10) Pub. No.: US 2014/0167556 A1
(43) Pub. Date: Jun. 19, 2014

(54) ELECTRIC ROTATING MACHINE

(71) Applicants: Itsuro Sawada, Tokyo (JP); Kanako Nemoto, Tokyo (JP); Hideaki Mori, Tokyo (JP); Satoshi Yamamura, Hitachinaka-shi (JP); Satoshi Kikuchi, Tokyo (JP)

(72) Inventors: Itsuro Sawada, Tokyo (JP); Kanako Nemoto, Tokyo (JP); Hideaki Mori, Tokyo (JP); Satoshi Yamamura, Hitachinaka-shi (JP); Satoshi Kikuchi, Tokyo (JP)

(73) Assignee: Hitachi Automotive Systems, Ltd., Hitachinaka-shi, Ibaraki (JP)

(21) Appl. No.: 14/236,649

(22) PCT Filed: Jul. 31, 2012
(86) PCT No.: PCT/JP2012/069488

§ 371 Date: Feb. 3, 2014

(30) Foreign Application Priority Data
Aug. 18, 2011 (JP) 2011-179024

(51) Int. Cl. H02K 1/18

(52) U.S. Cl. CPC H02K 1/185
USPC 310/216.009

(57) ABSTRACT

Disclosed is an electric rotating machine that includes a stator and a rotor. The stator includes a housing and a cylindrical stator core secured to the housing by shrinkage fitting. The rotor is rotatably disposed inside the stator. The stator core is formed of two or more circumferentially split cores. Spilt surfaces of the split cores are shaped in such a manner that the amount of distortion caused on the split surfaces on the outside diameter side by the shrinkage fitting is greater than the amount of distortion caused on the split surfaces on the inside diameter side by the shrinkage fitting.

### TECHNICAL FIELD

The present invention relates to an electric rotating machine.

### BACKGROUND ART

The electric rotating machine includes a rotor and a stator. A stator coil is wound around the stator. When the electric rotating machine is to be operated as an electric motor to obtain mechanical power, a current is allowed to flow to the stator coil to impart torque to the rotor. When electric power is to be generated by the electric rotating machine, the rotor is rotated by external torque to obtain a current generated from the stator coil.

When the electric rotating machine is to be operated, it is important to reduce copper loss, which occurs when a current flows to the stator coil, and iron loss, which occurs when an eddy current flows to a stator core.

A commonly employed technique for reducing the iron loss is to form the stator core by stacking thin magnetic steel plates that are electrically insulated from each other. In this instance, the stator core is formed by punching strip-shaped magnetic steel plates to form a circular shape, which is the shape of the stator core, and stacking the resultant circular magnetic steel plates. However, a low yield rate results because the magnetic steel plates remaining after punching to the shape of the stator core are wasted.

In view of the above circumstances, there is a known method of improving the yield of the stator core by forming the stator core with a plurality of split cores (refer to Patent Literature 1). Patent Literature 1 describes a punching arrangement method for a DC motor stator core that provides an improved material yield rate. Electric rotating machines based on the split cores are advantageous in terms of material cost and widely used.

The stator core formed of the split cores is secured by a housing. A widely used method of securing the stator core to the housing is a shrinkage fitting method. The shrinkage fitting method heats the housing in advance to a high temperature, allows the housing to thermally expand to increase its inside diameter, fits the housing onto the stator core, and cools the housing to secure the stator with the housing.

The difference at an ordinary temperature between the outside diameter of the stator core and the inside diameter of the housing is referred to as a tightening allowance. The tightening allowance is set so that the stator core does not idle in relation to the housing during an operation due to reaction caused by the torque of the rotor.

### CITATION LIST

### Patent Literature

Patent Literature 1: Japanese Unexamined Patent Application Publication No. 2002-320351

### SUMMARY OF INVENTION

### Technical Problem

When a great tightening allowance is set to increase a tightening force exerted by the housing, the stator core formed of the split cores can be steadily secured. However, the split cores are formed by stacking thin magnetic steel plates as mentioned earlier. It means that the strength of each magnetic steel plate is not high. Therefore, if the tightening force is increased, the split cores, which are adjacent to each other, may push each other to damage the contact portions of the adjacent split cores.

### Solution to Problem

According to a first aspect of the present invention, there is provided an electric rotating machine including a stator and a rotor. The stator includes a housing and a stator core. The stator core is cylindrical in shape and secured to the housing by shrinkage fitting. The rotor is rotatably disposed inside the stator. The stator core is formed of two or more circumferentially split cores. Split surfaces of the split cores are shaped in such a manner that the amount of distortion caused on the split surfaces on the outside diameter side by the shrinkage fitting is greater than the amount of distortion caused on the split surfaces on the inside diameter side by the shrinkage fitting.

According to a second aspect of the present invention, there is provided the electric rotating machine as described in the first aspect, wherein a convex or concave engagement portion is formed between the split surfaces on the outside diameter side and the split surfaces on the inside diameter side to engage adjacent split cores with each other.

According to a third aspect of the present invention, there is provided the electric rotating machine as described in the first or second aspect, wherein the split surfaces on the outside diameter side circumferentially protrude from the split surfaces on the inside diameter side.

According to a fourth aspect of the present invention, there is provided the electric rotating machine as described in the first or second aspect, wherein the split surfaces of the split cores are shaped in such a manner that when the outside diameter side split surface of one split core comes into contact with the outside diameter side split surface of another split core adjacent to the one split core, a gap is formed between the inside diameter side split surface of the one split core and the inside diameter side split surface of the other split core before the housing is shrinkage-fit and the inside diameter side split surface of the one split core comes into contact with the inside diameter side split surface of the other split core after the housing is shrinkage-fit.

According to a fifth aspect of the present invention, there is provided the electric rotating machine as described in the first or second aspect, wherein the inside diameter side split surfaces of the split cores are chamfered in a curved form.

According to a sixth aspect of the present invention, there is provided the electric rotating machine as described in the first or second aspect, wherein the inside diameter side split surfaces of the split cores are chamfered in a linear form.

### Advantageous Effects of Invention

When the shrinkage fitting method is exercised, the present invention makes it possible to prevent the contact portions of the adjacent split cores from being damaged.

### BRIEF DESCRIPTION OF DRAWINGS

FIG. 1 is a schematic diagram illustrating the configuration of a hybrid electric vehicle in which an electric rotating machine according to a first embodiment of the present invention is mounted.

FIG. 2 is a circuit diagram illustrating an electric power conversion device shown in FIG. 1.

FIG. 3 is a schematic diagram showing a partial cross-sectional view of the electric rotating machine according to the first embodiment.

FIG. 4 is a schematic diagram showing a transverse cross-sectional view of the electric rotating machine according to the first embodiment.

FIG. 5 is an external perspective view of a stator shown in FIG. 4.

FIG. 6 is an exploded perspective view of the stator shown in FIG. 4.

FIG. 7(a) is a perspective view of a split core on which a plastic bobbin is mounted, and FIG. 7(b) is a perspective view illustrating a state where a stator coil is wound around the plastic bobbin shown in FIG. 7(a).

FIG. 8 is a perspective view of the split core shown in FIG. 6.

FIG. 9 has schematic diagrams showing the shapes of split surfaces of split cores for the electric rotating machine according to the first embodiment.

FIG. 10 has schematic diagrams showing a partial enlargement of the split cores shown in FIG. 9, which are not shrinkage-fit.

FIG. 11 has schematic diagrams showing the shapes of the split surfaces of the split cores for the electric rotating machine according to a second embodiment of the present invention.

FIG. 12 has schematic diagrams showing the shape of the split surface of the split core for the electric rotating machine according to a third embodiment of the present invention.

FIG. 13 illustrates how electrical performance is affected by the length and width of a gap formed between the inside diameter side split surfaces of adjacent split cores.

FIG. 14 has schematic diagrams showing the shape of the split surface of the split core for the electric rotating machine according to a fourth embodiment of the present invention.

FIG. 15 is a schematic diagram showing the shape of the split surface of the split core for the electric rotating machine according to a fifth embodiment of the present invention.

FIG. 16 has schematic diagrams showing the shape of the split surface of the split core for the electric rotating machine according to a modified embodiment of the present invention.

### DESCRIPTION OF EMBODIMENTS

Embodiments of an electric rotating machine according to the present invention will now be described with reference to the accompanying drawings.

The electric rotating machine according to the embodiments of the present invention is preferably used to drive an electric vehicle and a hybrid electric vehicle.

### First Embodiment

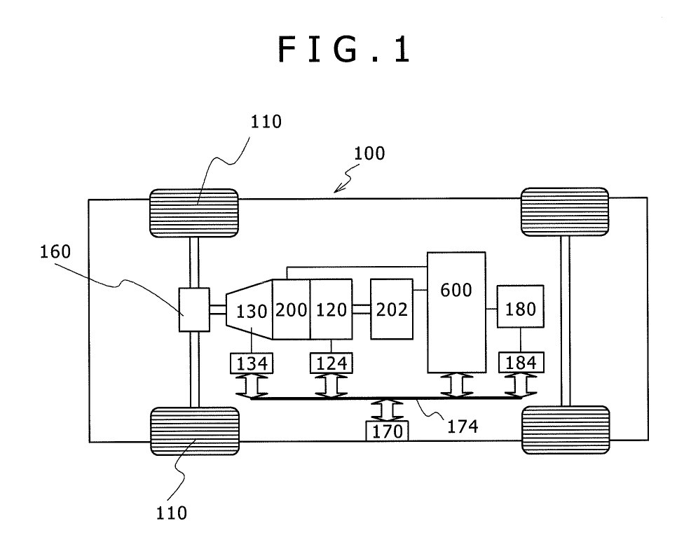

FIG. 1 is a schematic diagram illustrating the configuration of a hybrid electric vehicle in which the electric rotating machine according to a first embodiment of the present invention is mounted.

As shown in FIG. 1, the hybrid electric vehicle (hereinafter referred to as the vehicle) 100 includes an engine 120, a first electric rotating machine 200, a second electric rotating machine 202, and a battery 180.

The battery 180, which is formed of a lithium ion battery, a nickel hydride battery, or other secondary battery or of a capacitor, outputs DC power having a high voltage of 250 V to 600 V or higher. During power running, the battery 180 supplies the DC power to the electric rotating machines 200, 202. During regenerative running, on the other hand, the battery 180 receives DC power from the electric rotating machines 200, 202. The battery 180 and the electric rotating machines 200, 202 exchange DC power through an electric power conversion device 600.

A battery (not shown) for supplying low-voltage power (e.g., 14 V power) is mounted in the vehicle 100 to supply DC power to a control circuit described below.

Rotary torque derived from the engine 120 and from the electric rotating machines 200, 202 is transmitted to front wheels 110 through a transmission 130 and a differential gear 160. The transmission 130 is controlled by a transmission control device 134. The engine 120 is controlled by an engine control device 124. The battery 180 is charged and discharged under the control of a battery control device 184.

The transmission control device 134, the engine control device 124, the battery control device 184, and the electric power conversion device 600 are connected to an integrated control device 170 through a communication line 174.

The integrated control device 170 receives respective status information about the transmission control device 134, the engine control device 124, the electric power conversion device 600, and the battery control device 184 through the communication line 174. In accordance with the received information, the integrated control device 170 computes control commands for the control devices. The computed control commands are transmitted to the respective control devices through the communication line 174.

The battery control device 184 outputs status information about the charge and discharge of the battery 180 and about each unit cell of the battery to the integrated control device 170 through the communication line 174.

In accordance with the information output from the battery control device 194, the integrated control device 170 determines whether the battery 180 needs to be charged. If it is determined that the battery 180 needs to be charged, the integrated control device 170 issues an electric power generation command to the electric power conversion device 600.

The integrated control device 170 manages the output torque of the engine 120 and the output torque of the electric rotating machines 200, 202 and computes a total torque, which is the sum of the output torque of the engine 120 and the output torque of the electric rotating machines 200, 202, and a torque distribution ratio. In accordance with the result of the computation, the integrated control device 170 transmits appropriate control commands to the transmission control device 134, the engine control device 124, and the electric power conversion device 600.

In accordance with the control command transmitted from the integrated control device 170, the electric power conversion device 600 controls the electric rotating machines 200, 202 in such a manner as to generate a specified torque output or specified electric power. The electric power conversion device 600 includes a power semiconductor element that forms an inverter. The electric power conversion device 600 controls the switching operation of the power semiconductor element in accordance with the control command from the integrated control device 170. When the power semiconductor element performs the switching operation, the electric rotating machines 200, 202 operate as an electric motor or as a generator.

When the electric rotating machines 200, 202 are to be operated as an electric motor, the DC power from the high-voltage battery 180 is supplied to a DC terminal of the inverter in the electric power conversion device 600. The electric power conversion device 600 controls the switching operation of the power semiconductor element to convert the supplied DC power to three-phase AC power and supplies the three-phase AC power to the electric rotating machines 200, 202.

When, on the other hand, the electric rotating machines 200, 202 are to be operated as a generator, a rotor is rotationally driven by rotary torque applied from the outside to let a stator coil generate three-phase AC power. The generated three-phase AC power is converted to DC power by the electric power conversion device 600. The DC power is then supplied to the high-voltage battery 180 to charge the battery 180.

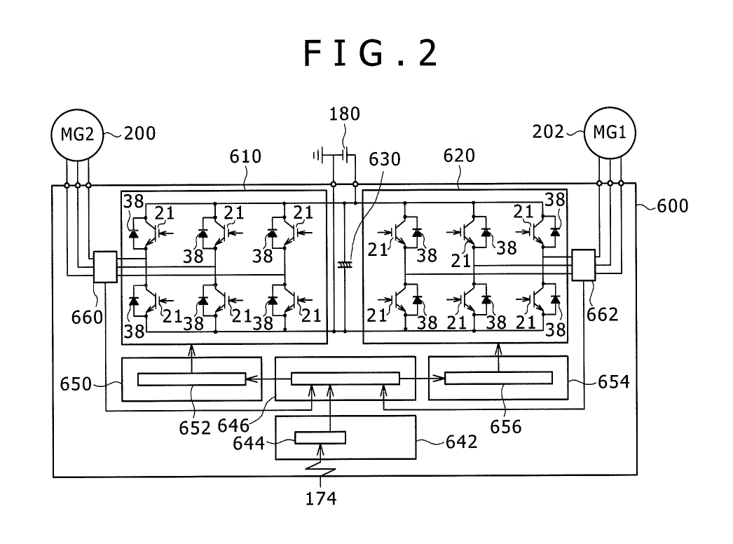

FIG. 2 is a circuit diagram illustrating the electric power conversion device 600 shown in FIG. 1. The electric power conversion device 600 includes a first inverter device for the first electric rotating machine 200 and a second inverter device for the second electric rotating machine 202. The first inverter device includes a power module 610, a first drive circuit 652 for controlling the switching operation of each power semiconductor element 21 in the power module 610, and a current sensor 660 for detecting a current of the electric rotating machine 200. The first drive circuit 652 is mounted on a drive circuit board 650.

The second inverter device includes a power module 620, a second drive circuit 656 for controlling the switching operation of each power semiconductor element 21 in the power module 620, and a current sensor 662 for detecting a current of the electric rotating machine 202. The second drive circuit 656 is mounted on a drive circuit board 654.

A control circuit 648 mounted on a control circuit board 646, a condenser module 630, and a transmitter/receiver circuit 644 mounted on a connector circuit board 642 are shared by the first inverter device and the second inverter device.

The power modules 610, 620 are operated by drive signals output from the associated drive circuits 652, 656. The power modules 610, 620 respectively convert the DC power supplied from the battery 180 to three-phase AC power and supplies the three-phase AC power to the stator coils or armature windings of the associated electric rotating machines 200, 202. The power modules 610, 620 convert AC power induced by the stator coils of the electric rotating machines 200, 202 to DC power and supplies the DC power to the high-voltage battery 180.

As shown in FIG. 2, the power modules 610, 620 each include a three-phase bridge circuit so that series circuits associated with three phases are electrically connected in parallel between positive and negative electrodes of the battery 180. Each series circuit includes a power semiconductor element 21, which forms an upper arm, and a power semiconductor element 21, which forms a lower arm. These power semiconductor elements 21 are connected in series.

The power module 610 has substantially the same circuit configuration as the power module 620 as shown in FIG. 2. Therefore, the power module 610 is described here as a representative.

In the present embodiment, an IGBT (insulated-gate bipolar transistor) is used as a switching power semiconductor element. The IGBT has three electrodes, namely, a collector electrode, an emitter electrode, and a gate electrode. A diode 38 is electrically connected between the collector electrode and the emitter electrode. The diode 38 has two electrodes, namely, a cathode electrode and an anode electrode. To ensure that the direction from the emitter electrode of the IGBT to the collector electrode of the IGBT is a forward direction, the cathode electrode is electrically connected to the collector electrode of the IGBT and the anode electrode is electrically connected to the emitter electrode of the IGBT.

The arms of the various phases are configured so that the emitter electrode of the IGBT is electrically connected in series with the collector electrode of the IGBT. In the present embodiment, only one IGBT is shown for the upper and lower arms of the various phases. However, as a large ampacity is to be controlled, a plurality of IGBTs are electrically connected in parallel in actuality.

The IGBT collector electrodes for the upper arms of the various phases are electrically connected to the positive electrode of the battery 180. The IGBT emitter electrodes for the lower arms of the various phases are electrically connected to the negative electrode of the battery 180. The midpoint of each arm of each phase (a joint between the upper arm side IGBT emitter electrode and the lower arm side IGBT collector electrode) is electrically connected to the armature winding (stator coil) of the associated phase of the associated electric rotating machine 200, 202.

The drive circuits 652, 656 form a drive section for controlling the power modules 610, 620 of the associated inverter device, and generate drive signals for driving the IGBTs in accordance with a control signal output from the control circuit 648. The drive signals generated by the drive circuits 652, 656 are respectively output to the gates of the power semiconductor elements 21 of the associated power modules 610, 620. Each of the drive circuits 652, 656 is provided with six integrated circuits that generate drive signals to be supplied to the gates of the upper and lower arms of the various phases, and is configured so that six integrated circuits form one block.

The control circuit 648 forms a control section for each inverter device and includes a microcomputer that computes a control signal (control value) for operating (turning on or off) the switching power semiconductor elements 21. A torque command signal (torque command value) from the integrated control device 170, the sensor outputs from the current sensors 660, 662, and the sensor outputs from rotation sensors (not shown) mounted in the electric rotating machines 200, 202 are input to the control circuits 648. In accordance with such input signals, the control circuit 648 computes a control value and outputs a switching timing control signal to the drive circuits 652, 656.

The transmitter/receiver circuit 644 mounted on the connector circuit board 642 establishes an electrical connection between the electric power conversion device 600 and an external control device and exchanges information with a remote device through the communication line 174 shown in FIG. 1.

The condenser module 630 forms a smoothing circuit for suppressing DC voltage changes caused by the switching operations of the power semiconductor elements 21, and is electrically connected in parallel to the DC terminals of the power modules 610, 620.

The structures of the electric rotating machines 200, 202 will now be described. The first electric rotating machine 200 has substantially the same circuit configuration as the second electric rotating machine 202. Therefore, the structure of the first electric rotating machine 200 is described below as a representative. The structure described below need not be adopted for both the electric rotating machines 200, 202. It may be adopted for only one of the two electric rotating machines 200, 202.

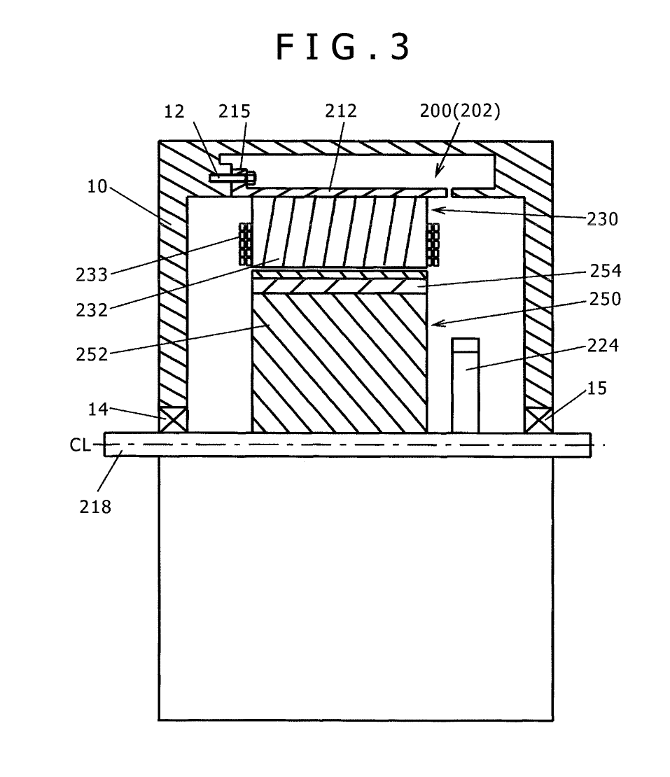

FIG. 3 is a schematic diagram showing a partial cross-sectional view of the electric rotating machine 200 according to the first embodiment mounted in a vehicle. As shown in FIG. 3, the electric rotating machine 200 is disposed in a vehicle side case 10, and includes a stator 230 and a rotor 250. The rotor 250 is rotatably disposed with a gap provided with respect to the inner circumference of the stator 230. The case 10 is integral with the case of the engine and with the case of the transmission.

The stator 230 has a cylindrical housing (shrinkage-fit ring) 212 and a stator core 232. The stator core 232 is secured to the inside of the housing 212. The stator 230 is secured to the inside of the case 10 when a flange provided for the housing 212 is fastened to the case 10 with a bolt 12.

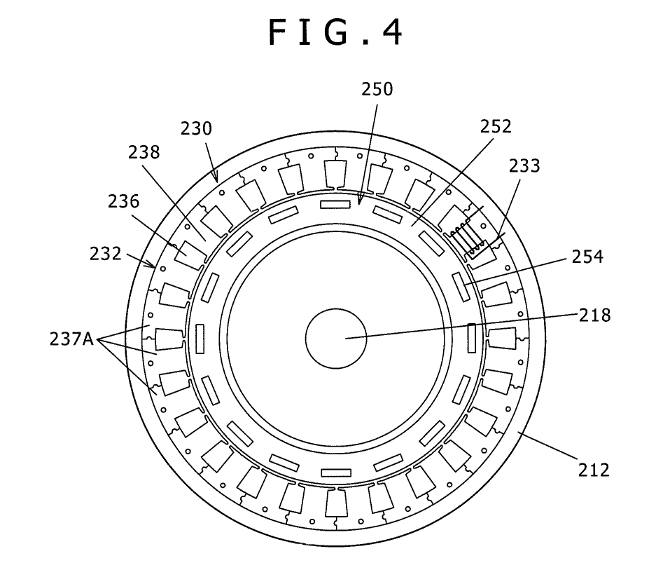

FIG. 4 is a schematic diagram showing a transverse cross-sectional view of the electric rotating machine 200 according to the first embodiment. As shown in FIGS. 3 and 4, the rotor 250 includes a rotor core 252 and permanent magnets 254. A shaft 218 is attached to the rotor core 252 so that they rotate together. As shown in FIG. 3, the shaft 218 is rotatably retained by bearings 14, 15 provided for the case 10.

The shaft 218 is provided with a resolver 224 that detects the pole position and rotation speed of the rotor 250. The output from the resolver 224 is input to the control circuit 648 shown in FIG. 2. In accordance with the output from the resolver 224, the control circuit 648 outputs a control signal to the drive circuit 652. The drive circuit 652 outputs a drive signal based on the control signal to the power module 610. As mentioned earlier, the power module 610 performs a switching operation in accordance with the control signal. For example, the power module 610 converts DC power supplied from the battery 180 to three-phase AC power. The three-phase AC power is supplied to the stator coil 233 shown in FIGS. 3 and 4 so that the stator 230 generates a rotating magnetic field. The frequency of the three-phase AC power is controlled in accordance with a value output from the resolver 224. The phases of the three-phase AC power relative to the rotor 250 is also controlled in accordance with the value output from the resolver 224.

As shown in FIGS. 3 and 4, the permanent magnets 254 are circumferentially disposed at regular intervals in the vicinity of the outer circumference of the rotor core 252. The permanent magnets 254 act as field poles for the rotor 250. In the present embodiment, the permanent magnets 254 provide 16 field poles. When a three-phase AC current flows to the stator coil 233 to let the stator 230 generate a rotating magnetic field, the rotating magnetic field acts on the permanent magnets 254 of the rotor 250 to generate torque.

As shown in FIGS. 3 and 4, the stator 230 includes the cylindrical stator core 232 and the stator coil 233. In the present embodiment, it is assumed that the diameter of the stator 230 is approximately 250 mm because such a diameter is required for the electric rotating machine 200 to generate an output power of approximately 300 kW.

As shown in FIG. 4, the stator coil 233 is wound around a tooth 238 of the stator core 232. For the sake of convenience, FIG. 4 schematically shows that the stator coil 233 is wound around one tooth 238. In reality, however, the stator coil 233 is wound around each tooth 238.

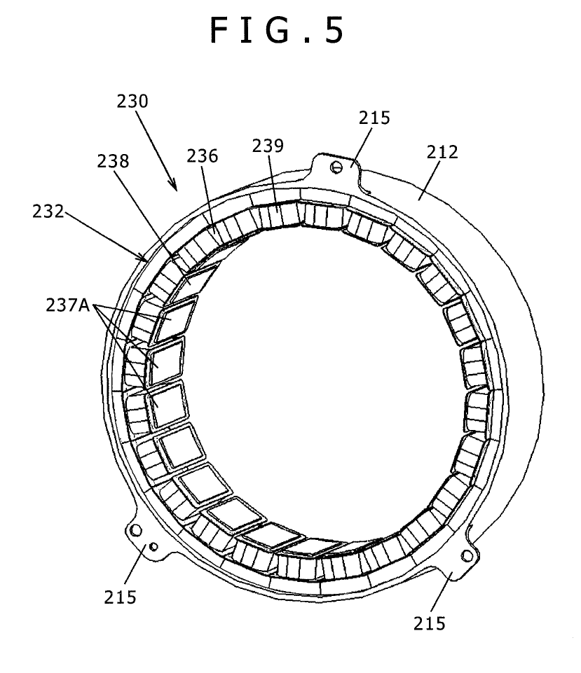

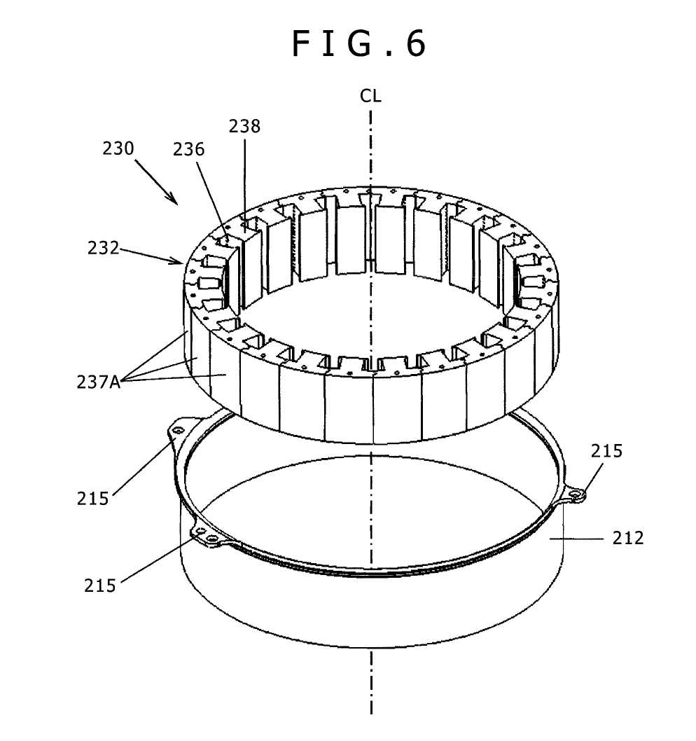

FIG. 5 is an external perspective view of the stator 230. FIG. 6 is an exploded perspective view of the stator 230. In FIG. 5, the stator coil 233 is not shown. In FIG. 6, the stator coil 233 and a later-described plastic bobbin 239 is not shown. As shown in FIGS. 4 to 6, the stator core 232 includes 24 split cores 237A. The 24 split cores 237A are circumferentially disposed to form a cylindrical shape. In other words, the stator core 232 is circumferentially divided into the 24 split cores 237A.

As shown in FIGS. 4 and 6, a plurality of slots 236 and the teeth 238, which are parallel to the center line CL of the stator core 232, namely, the rotation axis of the rotor 250, are circumferentially disposed at regular intervals on the inner circumferential side of the stator core 232, which is an assembly of the split cores. The split cores 237A each include one tooth 238 and are shaped like the letter T (see FIG. 4) as viewed from above so as to form one slot 236 between a pair of circumferentially adjacent split cores 237A.

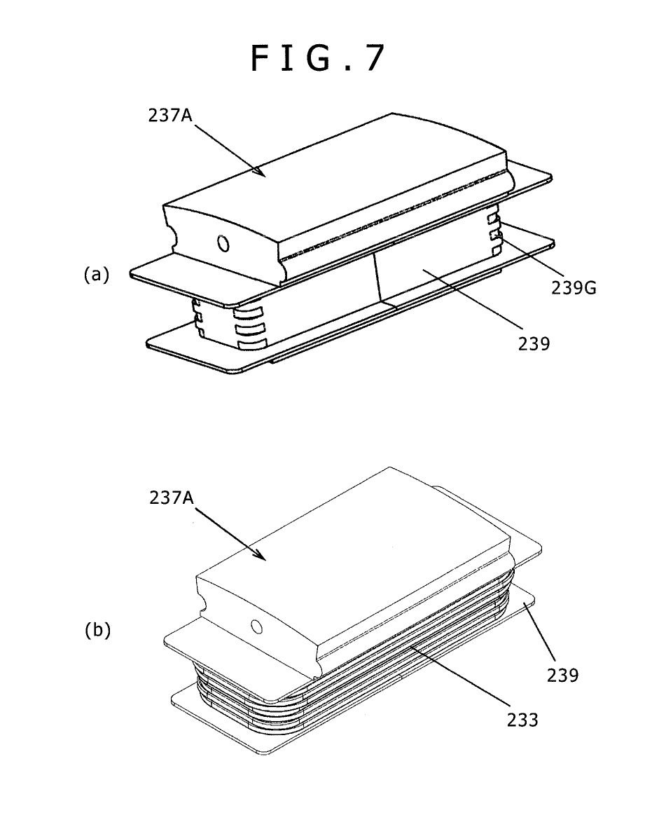

FIG. 7(a) is a perspective view of a split core 237A on which the plastic bobbin 239 is mounted. FIG. 7(b) is a perspective view illustrating a state where the stator coil 233 is wound around the plastic bobbin 239. As shown in FIG. 5 and FIG. 7(a), the plastic bobbin 239 is mounted on a tooth 238 of the split core 237A. As shown in FIG. 7(b), the stator coil 233 is concentratedly wound around the plastic bobbin 239. As shown in FIG. 7(a), a groove 239G is formed in the four corners of the plastic bobbin 239 to ensure that the stator coil 233, which is formed of a rectangular wire, is properly wound.

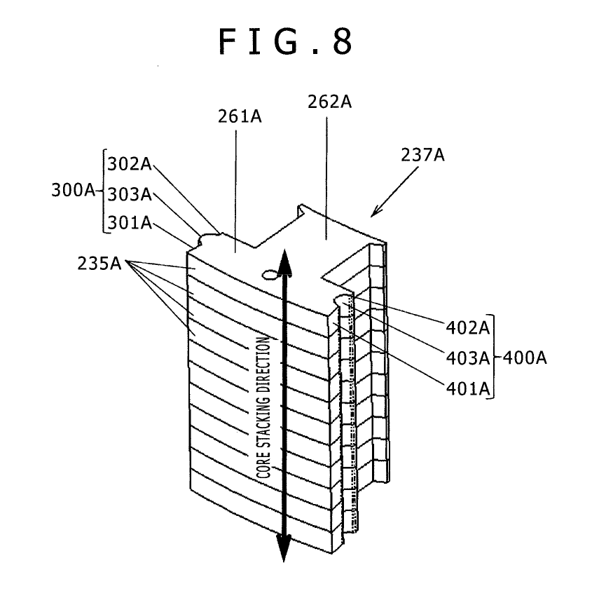

FIG. 8 is a perspective view of the split core 237A. As shown in FIG. 8, the split core 237A is obtained by stacking a plurality of core plates 235A, which are formed by press-punching silicon steel plates or magnetic steel plates having a thickness of approximately 0.05 to 1.0 mm. A direction in which the core plates 235A are stacked (hereinafter also referred to as the core stacking direction) is parallel to the direction of the rotation axis of the rotor 250.

The split core 237A includes a core back section 261A and a tooth section 262A. The core back section 261A forms a cylindrical core back when it is circumferentially disposed. The tooth section 262A protrudes in a radially-inward direction from the core back section 261A.

Split surfaces 300A, 400A are formed on both circumferential ends of the core back section 261A of the split core 237A. When a plurality of split cores 237A are circumferentially disposed (see FIG. 6), the split surface 300A of one split core 237A comes into contact with the split surface 400A of another split core 237A adjacent to the one split core 237A.

A convex surface 303A, which engages with a concave surface 403A formed on another split surface 400A of the other split core 237A adjacent to the one split core 237A, is formed on one split surface 300A of the one split core 237A. A concave surface 403A, which engages with a convex surface 303A formed on the one split surface 300A of the other split core 237A adjacent to the one split core 237A, is formed on the other split surface 400A of the one split core 237A.

As described above, the convex surface 303A and the concave surface 403A, which can engage with the adjacent split core 237A, are respectively formed on the split surfaces 300A, 400A of each split core 237A. This makes it easy to achieve positioning and dispose a plurality of split cores 237A in a cylindrical form to form the stator core 232, which is an assembly of the split cores.

The split surface 300A includes the convex surface 303A, an outside diameter side split surface 301A, and an inside diameter side split surface 302A. The outside diameter side split surface 301A and the inside diameter side split surface 302A are formed with the convex surface 303A positioned in-between. The split surface 400A includes the concave surface 403A, an outside diameter side split surface 401A, and an inside diameter side split surface 402A. The outside diameter side split surface 401A and the inside diameter side split surface 402A are formed with the concave surface 403A positioned in-between.

The stator core 232, which is an assembly of the split cores, is secured by the housing 212 by shrinkage fitting as described later. When a shrinkage fitting method is exercised, the housing 212 thermally shrinks so that the split surface 300A of one of adjacent split cores 237A and the split surface 400A of the other split core 237A push each other. When the split surface 300A and the split surface 400A push each other, they become distorted.

In the present embodiment, the split surfaces 300A, 400A of the split cores 237A are shaped in such a manner that the amount of distortion caused on the outside diameter side split surfaces 301A, 401A by shrinkage fitting is greater than the amount of distortion caused on the inside diameter side split surfaces 302A, 402A by shrinkage fitting. The shapes of the split surfaces 300A, 400A will be described later.

As shown in FIGS. 4 to 6, the housing (shrinkage-fit ring) 212 is formed of a steel plate (e.g., high-tensile steel plate) having a thickness of approximately 2 to 5 mm and is drawn into a cylindrical shape. The inside diameter of the housing 212 is such that the housing 212 can be shrinkage-fit on the outer circumference of the stator core 232. The housing 212 is dimensioned to an accuracy of approximately 1/10 to 1/100 mm. The inside diameter and thickness of the housing 212 are determined in consideration, for instance, of tensile stress derived from shrinkage fitting.

As shown in FIGS. 5 and 6, one end of the housing 212 is provided with a plurality of flanges 215, which are used for attaching the housing 212 to the case 10. The flanges 215 protrude in a radially-outward direction from the rim of one end face of the cylindrical housing 212.

The stator core 232 is secured to the inside of the housing 212 by shrinkage fitting. More specifically, the housing 212, whose inside diameter is thermally expanded in advance by heating, is fit into the stator core 232, which is an assembly of split cores and obtained by assembling the split cores 237A in a cylindrical form. The housing 212 is then cooled down to decrease its inside diameter. When such thermal shrinkage occurs, the housing 212 secures the outer circumference of the stator core 232.

The inside diameter of the housing 212 is set to be smaller by a predetermined value than the outside diameter the stator core 232 so that the stator core 232 does not idle in relation to the housing 212 during an operation due to reaction caused by the torque of the rotor 250. This ensures that the stator core 232 is securely fastened by shrinkage fitting to the inside of the housing 212.

The difference at an ordinary temperature between the outside diameter of the stator core 232 and the inside diameter of the housing 212 is referred to as a tightening allowance. When the tightening allowance is set in accordance with the maximum torque generated when the electric rotating machine 200 generates its maximum output, the housing 212 exerts a predetermined tightening force to secure the stator core 232.

When the housing 212 shrinks to exert the tightening force on the stator core 232, adjacent split cores 237A push each other. This generates compressive stress on the contact portions of the split cores 237A.

As mentioned earlier, the stator core 232 is formed by stacking silicon steel plates or magnetic steel plates having a thickness of approximately 0.05 to 1.0 mm in order to reduce the loss of the electric rotating machine 200. As the silicon steel plates or magnetic steel plates forming the stator core 232 are very thin as mentioned above, the stator core 232 has a low strength with respect to a force exerted in a direction orthogonal to the core stacking direction (equivalent to the radial direction and circumferential direction orthogonal to the rotation axis of the rotor 250) is low although it has a high strength with respect to a force exerted in the core stacking direction.

In the past, the contact portions of the split cores 237A occasionally became damaged (buckled) due to compressive stress exerted when the housing 212 was shrinkage-fit on the stator core 232. It should be noted that the inner circumference of each split core 237A is not secured although its outer circumference is secured by the housing 212 due to shrinkage fitting. That is why the inside diameter side split surfaces 302A, 402A out of the split surfaces 300A, 400A of the core back section 261A became damaged.

In view of the above circumstances, in the first embodiment of the present invention, the split surfaces 300A, 400A of the split cores 237A are shaped in such a manner that the amount of distortion caused on the inside diameter side split surfaces 302A, 402A when the housing 212 is shrinkage-fit is smaller than the amount of distortion caused on the outside diameter side split surfaces 301A, 401A. This prevents the inside diameter side split surfaces 302A, 402A from being damaged by compressive stress generated during shrinkage fitting. Details are described below.

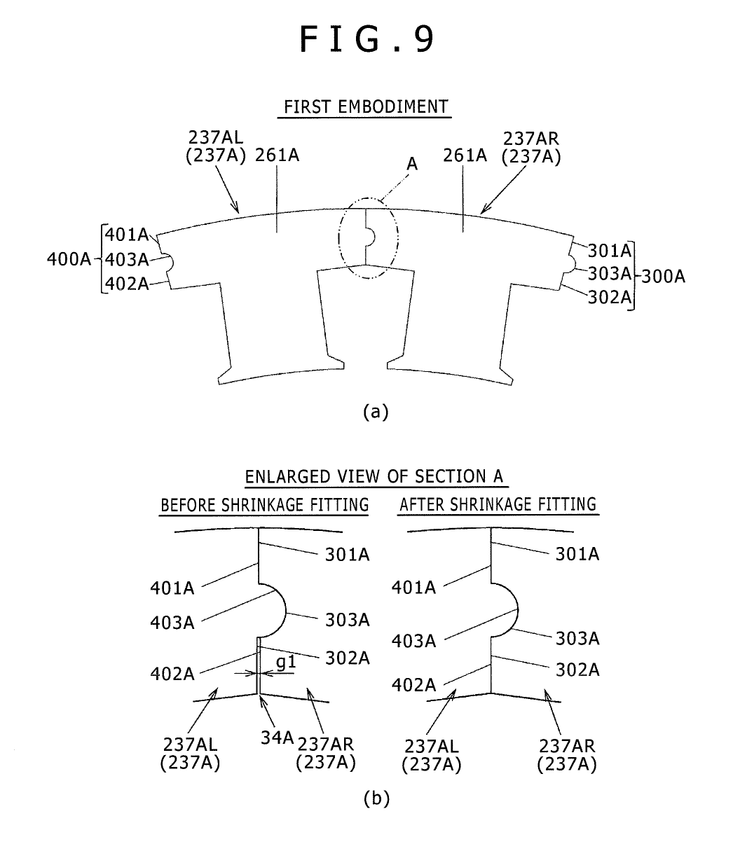

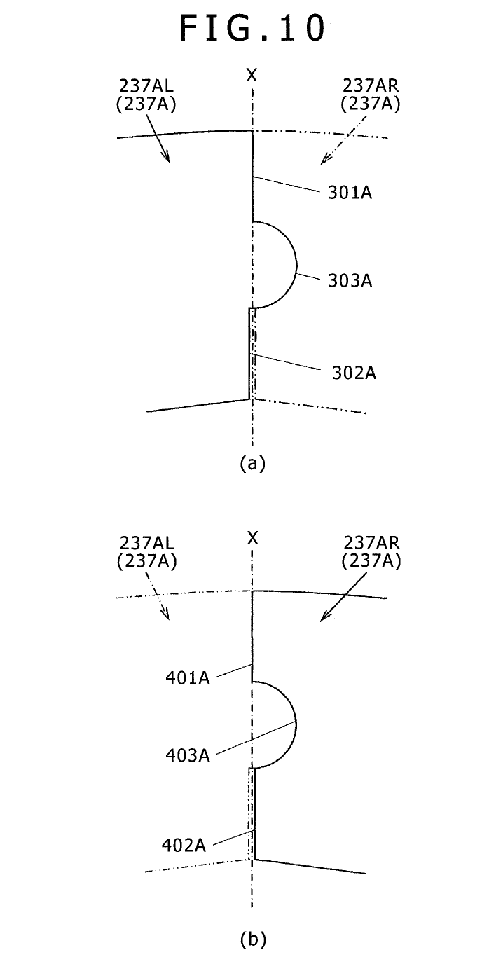

FIG. 9 has schematic diagrams showing the shapes of the split surfaces 300A, 400A of the split cores 237A for the electric rotating machine 200 according to the first embodiment of the present invention. FIG. 9(a) is a schematic diagram showing a plan view of two circumferentially disposed split cores 237A. FIG. 9(b) is an enlarged view of section A in FIG. 9(a). More specifically, FIG. 9(b) schematically shows an enlarged view obtained before shrinkage fitting and an enlarged view obtained after shrinkage fitting. In FIG. 9(b), the width of a gap 34A formed before shrinkage fitting is exaggerated. FIG. 10 has schematic diagrams showing a partial enlargement of the split cores 237A prevailing before shrinkage fitting. FIG. 10(a) uses a solid line to indicate the split core 237A shown at left and uses a two-dot chain line to indicate the split core 237A shown at right. FIG. 10(b) uses a solid line to indicate the split core 237A shown at right and uses a two-dot chain line to indicate the split core 237A shown at left.

As shown in FIG. 9(a), the two split cores 237A are disposed so that the convex surface 303A of one split core 237A (which is the split core shown at left and hereinafter designated at 237AL) is engaged with the concave surface 403A of another split core 237A adjacent to the split core 237AL (which is the split core shown at right and hereinafter designated at 237AR). As shown in FIGS. 9(b), 10(a), and 10(b), the outside diameter side split surface 301A of the split core 237AL is in contact with the outside diameter side split surface 401A of the split core 237AR before shrinkage fitting. As shown in FIGS. 10(a) and 10(b), the contact surface between the split surface 301A and the split surface 401a is in a depicted virtual plane X. The virtual plane X contains the center line CL of the stator core 232 shown in FIG. 6, namely, the rotation axis of the rotor 250.

As shown in FIG. 10(a), the inside diameter side split surface 302A of the split core 237AL shown at left is positioned to the left of the virtual plane X. As shown in FIG. 10(b), the inside diameter side split surface 402A of the split core 237AR shown at right is positioned to the right of the virtual plane X. In other words, the split core 237AL shown at left is formed in such a manner that the outside diameter side split surface 301A circumferentially protrudes from the inside diameter side split surface 302A. Similarly, the split core 237AR shown at right is formed in such a manner that the outside diameter side split surface 401A circumferentially protrudes from the inside diameter side split surface 402A.

As shown in FIG. 9(b), before shrinkage fitting, when a plurality of split cores 237A are circumferentially disposed and the outside diameter side split surface 301A of one split core 237AL is brought into contact with the outside diameter side split surface 401A of another split core 237AR adjacent to the split core 237AL, the gap 34A is formed between the inside diameter side split surface 302A of the split core 237AL and the inside diameter side split surface 402A of the split core 237AR. The gap 34A is formed so that its width g1 is approximately 100 μm and that its radial length is approximately 30% of the radial length of the core back section 261A.

As shown in FIG. 9(b), after the housing 212 is shrinkage-fit, the inside diameter side split surface 302A of the split core 237AL is in contact with the split surface 402A of the other split core 237AR adjacent to the split core 237AL.

As described above, before shrinkage fitting, the inside diameter side split surface 302A and split surface 402A are not in contact with each other although the outside diameter side split surface 301A and split surface 401A are in contact with each other. In the present embodiment, the split surfaces 300A, 400A of each split core 237A are shaped so that the gap 34A is formed between the inside diameter side split surfaces 302A, 402A before shrinkage fitting, and that the inside diameter side split surfaces 302A, 402A are in contact with each other after shrinkage fitting. Therefore, after shrinkage fitting, the amount of distortion caused do the inside diameter side split surfaces 302A, 402A can be smaller than the amount of distortion caused on the outside diameter side split surfaces 301A, 401A.

Consequently, the compressive stress generated on the inside diameter side, low-strength split surfaces 302A, 402A of the core back section 261A can be reduced. This makes it possible to prevent the split cores 237A from being damaged when the housing 212 is shrinkage-fit.

The present embodiment, which has been described above, provides the following advantageous effects.

(1) The split surfaces 300A, 400A of the split cores 237A adjacent to each other are shaped so that the amount of distortion caused on the outside diameter side split surfaces 301A, 401A due to shrinkage fitting is greater than the amount of distortion caused on the inside diameter side split surfaces 302A, 402A due to shrinkage fitting. This prevents the contact surfaces of split cores 237A adjacent to each other from being damaged during shrinkage fitting.

(2) The split surfaces 300A, 400A of each split core 237A are shaped so that before the housing 212 is shrinkage-fit, the gap 34A is formed between the inside diameter side split surface 302A of the split core 237AL and the inside diameter side split surface 302A of the split core 237AR when the outside diameter side split surface 301A of the split core 237AL is brought into contact with the outside diameter side split surface 401A of the split core 237AR. Further, the split surfaces 300A, 400A of each split core 237A are shaped so that after the housing 212 is shrinkage-fit, the inside diameter side split surface 302A of the split core 237AL is in contact with the inside diameter side split surface 402A of the split core 237AR. This suppresses the deterioration of electrical performance, for example, a decrease in torque value.

(3) The convex surface 303A is provided between the outside diameter side split surface 301A and the inside diameter side split surface 302A to engage two adjacent split cores 237A, and the concave surface 403A is provided between the outside diameter side split surface 401A and the inside diameter side split surface 402A to engage the two adjacent split cores 237A. This makes it easy to achieve positioning and dispose a plurality of split cores 237A in a cylindrical form to form the stator core 232, which is an assembly of the split cores. As a result, manufacturing man-hours can be reduced to achieve manufacturing cost reduction.

### Second Embodiment

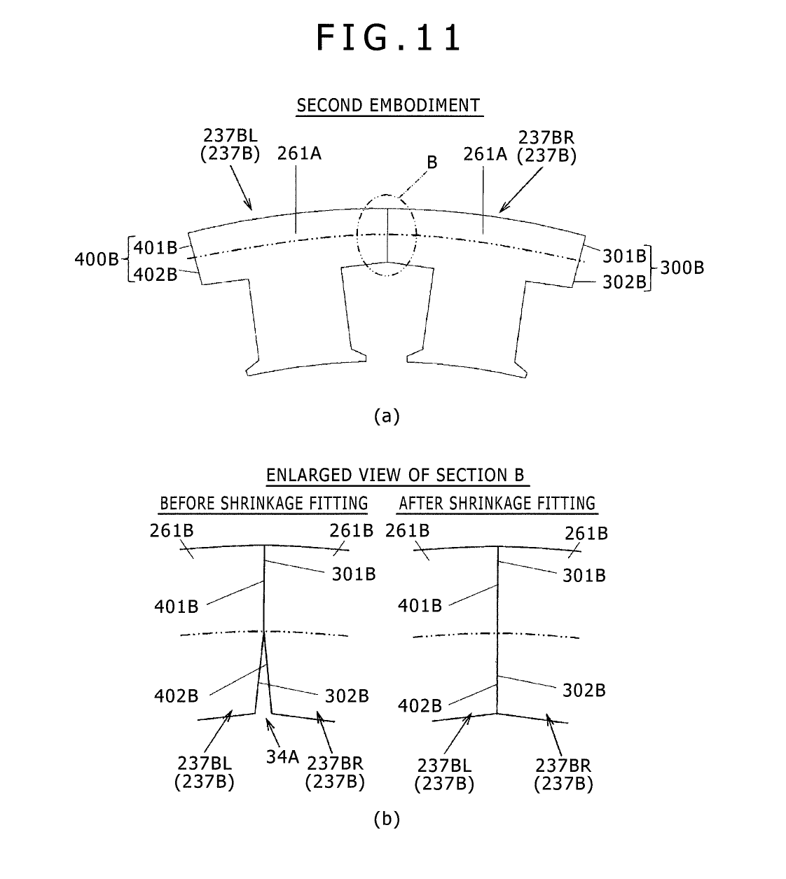

The electric rotating machine according to a second embodiment of the present invention will now be described with reference to FIG. 11. FIG. 11 has schematic diagrams showing the shapes of split surfaces 300B, 400B of split cores 237B for the electric rotating machine according to the second embodiment. FIG. 11(a) is a schematic diagram showing a plan view of two circumferentially disposed split cores 237B. FIG. 11(b) is an enlarged view of section B in FIG. 11(a). More specifically, FIG. 11(b) schematically shows an enlarged view obtained before shrinkage fitting and an enlarged view obtained after shrinkage fitting. In FIG. 11(b), the size of a gap 34B formed before shrinkage fitting is exaggerated. In FIG. 11, elements identical with or equivalent to those used in the first embodiment are designated by like reference numerals suffixed by the letter B. The second embodiment will be described mainly with reference to the differences from the first embodiment.

As shown in FIG. 11(a), the electric rotating machine according to the second embodiment does not have engagement portions, namely, the convex surface 303A and the concave surface 403A (see FIG. 9) so that there is no definite boundary between the outside diameter side split surfaces 301B, 401B and the inside diameter side split surfaces 302B, 402B. In the second embodiment, before shrinkage fitting, when a plurality of split cores 237B are circumferentially disposed and the outside diameter side split surface 301B of one split core 237B (which is the split core shown at left and hereinafter designated at 237BL) is brought into contact with the outside diameter side split surface 401B of another split core 237B (which is the split core shown at right and hereinafter designated at 237BR) adjacent to the split core 237BL, the gap 34B is formed between the inside diameter side split surface 302B of the split core 237BL and the inside diameter side split surface 402B of the split core 237BR as shown in FIG. 11(b).

The gap 34B is formed so that its width gradually increases toward both circumferential sides from the radial center of the core back section 2618 to the inside diameter portion. In other words, the split core 237BL is formed so that the outside diameter side split surface 301B circumferentially protrudes from the inside diameter side split surface 302B, whereas the other split core 237BR adjacent to the split core 237BL is formed so that the outside diameter side split surface 401B circumferentially protrudes from the inside diameter side split surface 402B. As shown in FIG. 11(b), after the housing 212 is shrinkage-fit, the inside diameter side split surface 302B of the split core 237BL is in contact with the inside diameter side split surface 402BR of the other split core 237B adjacent to the split core 237BL.

As described above, before shrinkage fitting, the inside diameter side split surface 302B and split surface 402B are not in contact with each other although the outside diameter side split surface 301B and split surface 401B are in contact with each other. In the second embodiment, the split surfaces 300B, 400B of each split core 237B are shaped so that the gap 34B is formed between the inside diameter side split surfaces 302B, 402B before shrinkage fitting, and that the inside diameter side split surfaces 302B, 402B are in contact with each other after shrinkage fitting. Therefore, after shrinkage fitting, the amount of distortion caused on the inside diameter side split surfaces 302B, 402B can be smaller than the amount of distortion caused on the outside diameter side split surfaces 301B, 401B.

Consequently, the second embodiment provides the same advantageous effects as advantageous effects (1) and (2), which are described in conjunction with the first embodiment.

### Third Embodiment

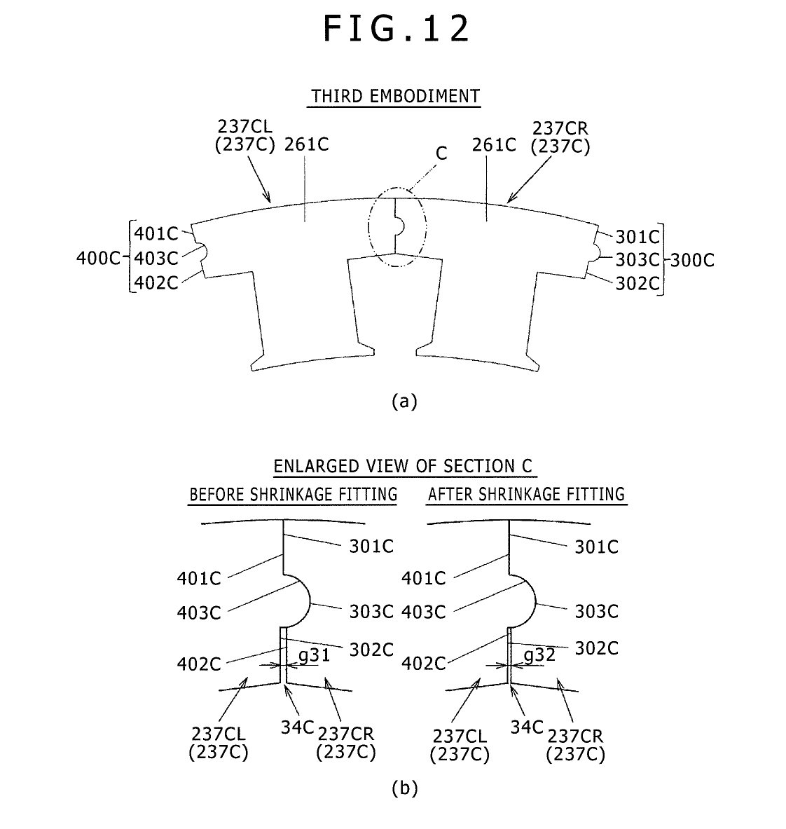

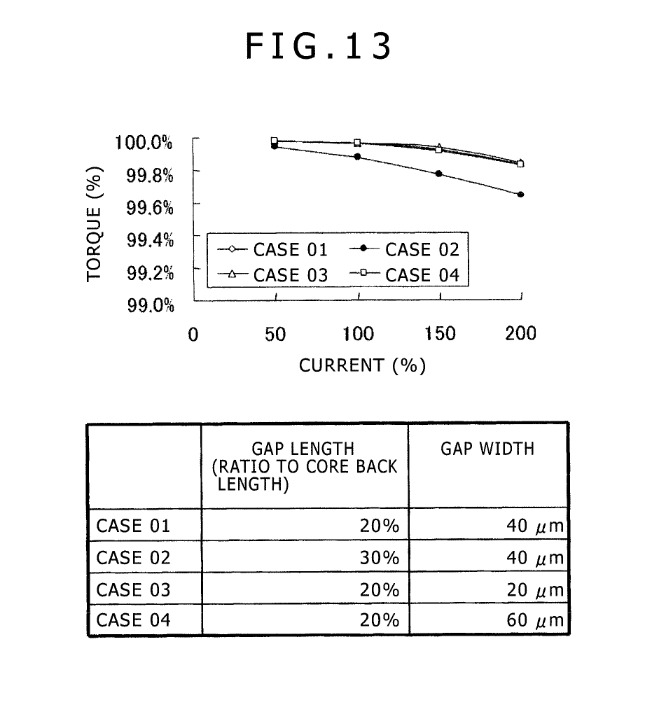

The electric rotating machine according to a third embodiment of the present invention will now be described with reference to FIGS. 12 and 13. FIG. 12 has schematic diagrams showing the shapes of split surfaces 300C, 400C of split cores 237C for the electric rotating machine according to the third embodiment. FIG. 12(a) is a schematic diagram showing a plan view of two circumferentially disposed split cores 237C. FIG. 12(b) is an enlarged view of section C in FIG. 12(a). More specifically, FIG. 12(b) schematically shows an enlarged view obtained before shrinkage fitting and an enlarged view obtained after shrinkage fitting. In FIG. 12(b), the width of a gap 34C formed before and after shrinkage fitting is exaggerated. In FIG. 12, elements identical with or equivalent to those used in the first embodiment are designated by like reference numerals suffixed by the letter C. The third embodiment will be described mainly with reference to the differences from the first embodiment.

As shown in FIG. 12(a), the electric rotating machine according to the third embodiment is configured so that a convex surface 303C and a concave surface 403C are formed on the split surfaces 300C, 400C of the split cores 237C, as is the case with the electric rotating machine according to the first embodiment. The convex surface 303C and the concave surface 403C are formed so as to engage two adjacent split cores 237C.

The split surface 300C includes the convex surface 303C, an outside diameter side split surface 301C, and an inside diameter side split surface 302C. The outside diameter side split surface 301C and the inside diameter side split surface 302C are formed with the convex surface 303C positioned in-between. The split surface 400C includes the concave surface 403C, an outside diameter side split surface 401C, and an inside diameter side split surface 402C. The outside diameter side split surface 401C and the inside diameter side split surface 402C are formed with the concave surface 403C positioned in-between.

As shown in FIG. 11(b), which is an enlarged view obtained before shrinkage fitting, one split core 237C (which is the split core shown at left and hereinafter designated at 237CL) is formed so that the outside diameter side split surface 301C circumferentially protrudes from the inside diameter side split surface 302C. Similarly, another split core 237C (which is the split core shown at right and hereinafter designated at 237CR) adjacent to the split core 237CL is formed so that the outside diameter side split surface 401C circumferentially protrudes from the inside diameter side split surface 402C.

Before shrinkage fitting, when a plurality of split cores 237C are circumferentially disposed and the outside diameter side split surface 301C of the one split core 237CL is brought into contact with the outside diameter side split surface 401C of the other split core 237CR adjacent to the split core 237CL, the gap 34C is formed between the inside diameter side split surface 302C of the split core 237CL and the inside diameter side split surface 402C of the split core 237CR as shown in FIG. 11(b).

As shown in FIG. 12(b), the width of the gap 34C changes due to shrinkage fitting so that the width g32 prevailing after shrinkage fitting is smaller than the width g31 prevailing before shrinkage fitting (g31>g32). However, it should be noted that the gap 34C still exists after the housing 212 is shrinkage-fit. In other words, no distortion occurs on the inside diameter side split surfaces 302C, 402C after shrinkage fitting. Consequently, the third embodiment provides the same advantageous effects as advantageous effects (1) and (3), which are described in conjunction with the first embodiment.

After shrinkage fitting, the radial length of the gap 34C is approximately 30% of the radial length of the core back section 261C, and the width g32 of the gap 34C is approximately 40 μm. This makes it possible to minimize the deterioration of electrical performance.

### Analysis Example

The influence of the radial length and width g32 of the gap 34C formed between the inside diameter side split surfaces 302C, 402C of two adjacent split cores 237C on electrical performance is described below. The graph of FIG. 13 shows the result of an analysis. In the graph, the horizontal axis represents the value of a current and the vertical axis represents torque. The graph is based on the assumption that the torque prevailing at a current value of 50% when there is no gap after shrinkage fitting is 100%. The graph is obtained by plotting torque values prevailing at current values of 50%, 100%, 150%, and 200% under various conditions (Cases 01 to 04).

As indicated by the analysis result, the degree of electrical performance deterioration is extremely small in each case. If the radial length of the gap 34C formed after shrinkage fitting is approximately 30% of the radial length of the core back section 261C and the width g32 of the gap 34C formed after shrinkage fitting is approximately 40 μm, a decrease in the torque is smaller than 0.5% when the same current is allowed to flow. The degree of electrical performance deterioration is extremely small as compared to a case where no gap is formed.

### Fourth Embodiment

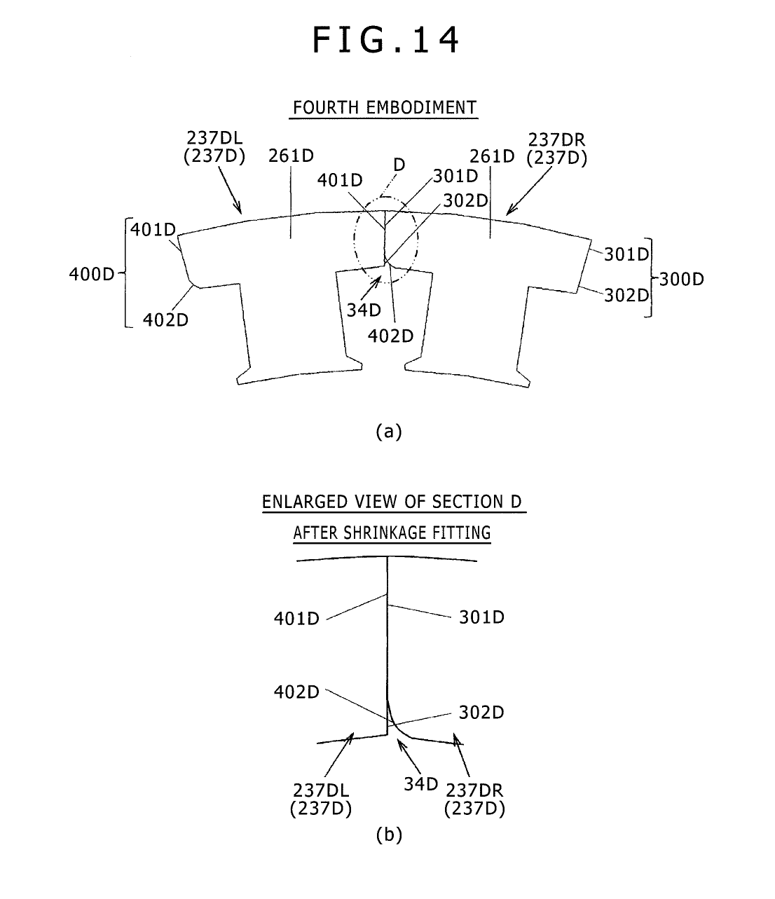

The electric rotating machine according to a fourth embodiment of the present invention will now be described with reference to FIG. 14. FIG. 14 has schematic diagrams showing the shapes of split surfaces 300D, 400D of split cores 237D for the electric rotating machine according to the fourth embodiment. FIG. 14(a) is a schematic diagram showing a plan view of two circumferentially disposed split cores 237D. FIG. 14(b) is an enlarged view of section D in FIG. 14(a). More specifically, FIG. 14(b) schematically shows an enlarged view obtained after shrinkage fitting. In FIG. 14, the width of a gap 34D formed before and after shrinkage fitting is exaggerated. In FIG. 14, elements identical with or equivalent to those used in the second embodiment are designated by like reference numerals suffixed by the letter D. The fourth embodiment will be described mainly with reference to the differences from the second embodiment.

As shown in FIG. 14(a), the fourth embodiment is configured so that one split surface 400D of each split core 237D is chamfered in a curved form as viewed from above. The other split surface 300D of each split core 237D, on the other hand, is formed so that the outside diameter side split surface 301D is flush with the inside diameter side split surface 302D.

In the electric rotating machine according to the fourth embodiment, before shrinkage fitting, when a plurality of split cores 237D are circumferentially disposed and the outside diameter side split surface 301D of one split core 237D (which is the split core shown at left and hereinafter designated at 237DL) is brought into contact with the outside diameter side split surface 401D of another split core 237D (which is the split core shown at right and hereinafter designated at 237DR) adjacent to the split core 237DL, the gap 34D is formed between the inside diameter side split surface 302D of the split core 237DL and the inside diameter side split surface 402D of the split core 237DR as shown in FIG. 14(a).

As shown in FIG. 14(b), the gap 34D still exists after the housing 212 is shrinkage-fit. In other words, no distortion occurs on the inside diameter side split surfaces 302D, 402D after shrinkage fitting.

In the fourth embodiment, the inside diameter side split surface 402D of one split surface 400D out of both split surfaces 300D, 400D of a core back section 261D is chamfered in a curved form as viewed from above to form the gap 34D in such a manner that its width gradually increases in a direction toward the inside diameter. In other words, the split core 237D is formed so that the outside diameter side split surface 401D of one split surface 400D out of both split surfaces 300D, 400D of the core back section 261D circumferentially protrudes from the inside diameter side split surface 402D.

As described above, the fourth embodiment is configured so that the gap 34D is formed by chamfering in a curved form as viewed from above. Consequently, the fourth embodiment provides the same advantageous effect as advantageous effect (1), which is described in conjunction with the first embodiment.

### Fifth Embodiment

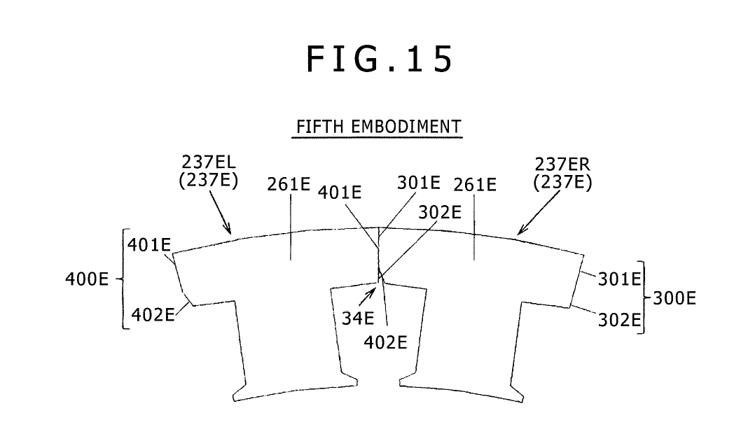

The electric rotating machine according to a fifth embodiment of the present invention will now be described with reference to FIG. 15. FIG. 15 is a schematic diagram showing the shapes of split surfaces 300E, 400E of split cores 237E for the electric rotating machine according to the fifth embodiment. In FIG. 15, the width of a gap 34E formed before shrinkage fitting is exaggerated. In FIG. 15, elements identical with or equivalent to those used in the fourth embodiment are designated by like reference numerals suffixed by the letter E. The fifth embodiment will be described mainly with reference to the differences from the fourth embodiment.

In the electric rotating machine according to the fifth embodiment, before shrinkage fitting, when a plurality of split cores 237E are circumferentially disposed and the outside diameter side split surface 301E of one split core 237E (which is the split core shown at left and hereinafter designated at 237EL) is brought into contact with the outside diameter side split surface 401E of another split core 237E (which is the split core shown at right and hereinafter designated at 237ER) adjacent to the split core 237EL, the gap 34E is formed between the inside diameter side split surface 302E of the split core 237EL and the inside diameter side split surface 402E of the split core 237ER, as is the case with the electric rotating machine according to the fourth embodiment.

Although not shown, the gap 34E still exists after the housing 212 is shrinkage-fit. In other words, no distortion occurs on the inside diameter side split surfaces 302E, 402E after shrinkage fitting. In the fifth embodiment, the inside diameter side split surface 402E of one split surface 400E out of both split surfaces 300E, 400E of a core back section 261E is chamfered in a linear form as viewed from above to form the gap 34E in such a manner that its width gradually increases in a direction toward the inside diameter. In other words, the split core 237E is formed so that the outside diameter side split surface 401E of one split surface 400E out of both split surfaces 300E, 400E of the core back section 261E circumferentially protrudes from the inside diameter side split surface 402E.

As described above, the fifth embodiment is configured so that the gap 34E is formed by chamfering in a linear form as viewed from above. Consequently, the fifth embodiment provides the same advantageous effect as advantageous effect (1), which is described in conjunction with the first embodiment.

Modified embodiments described below are also within the scope of the present invention. One or more of the modified embodiments may be combined with one of the foregoing embodiments.

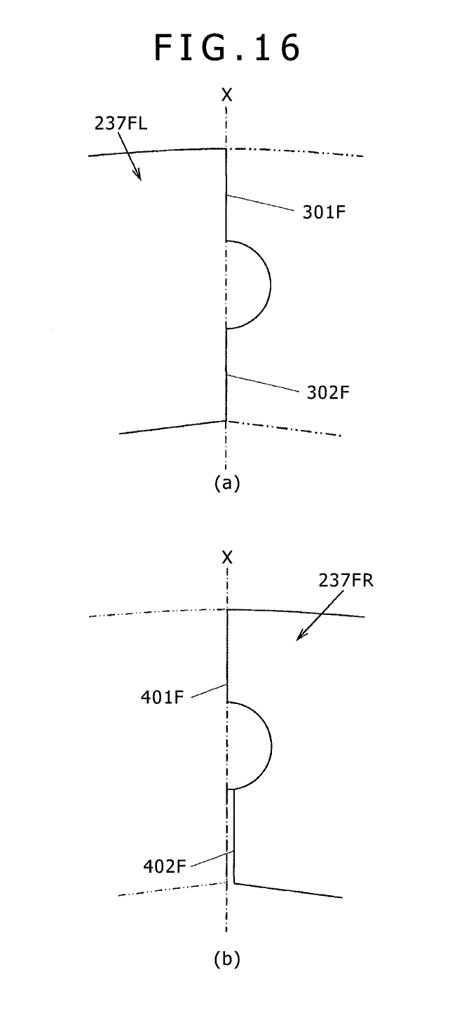

(1) The first to third embodiments have been described on the assumption that the outside diameter side split surface of each of both split surfaces of the core back section circumferentially protrudes from the inside diameter side split surface. However, the present invention is not limited to such a configuration. As shown, for instance, in FIG. 16(a), the split surface of a split core 237FL shown at left may alternatively be configured to form split surfaces 301F, 302F in such a manner that the outside diameter side split surface 301F is flush with the inside diameter side split surface 302F. As shown, for instance, in FIG. 16(b), the split surface of a split core 237FR shown at right may alternatively be configured to form split surfaces 401F, 402F in such a manner that the outside diameter side split surface 401F circumferentially protrudes from the inside diameter side split surface 402F.

(2) The fourth and fifth embodiments have been described on the assumption that one of both split surfaces of the core back section is chamfered. However, the present invention is not limited to such a configuration. Alternatively, both split surfaces of the core back section may be chamfered.

(3) The shapes of the split surfaces of the split cores are not limited to the shapes according to the first and second embodiments. The present invention can also be applied to various other shapes. For example, the inside diameter side split surfaces of two adjacent split cores may be shaped to form a gap therebetween before shrinkage fitting and come into contact with each other after shrinkage fitting.

(4) The shape of the gap formed after shrinkage fitting between the inside diameter side split surfaces of two adjacent split cores is not limited to the shapes according to the third to fifth embodiments. Alternatively, the gap may be formed in various manners so that the inside diameter side split surfaces of two adjacent split cores are not in contact with each other after shrinkage fitting.

(5) The foregoing embodiments have been described on the assumption that the housing (shrinkage-fit ring) 212 is shaped like a circular cylinder. However, the present invention is not limited to the use of a cylindrical housing. Instead of being shaped like a cylinder the both ends of which are open, the housing 212 may alternatively be shaped like a cup. More specifically, the housing 212 may be shaped so that one of its ends is closed by a bottom plate. Another alternative is to use a housing shaped like a polygonal cylinder instead of a circular cylinder. In other words, the housing 212 may be of various shapes as far as it has an inner circumferential shape that corresponds to the outer circumference of the stator core 232 assembled of a plurality of split cores.

(6) The foregoing embodiments have been described on the assumption that the stator core 232 is formed of 24 split cores. However, the present invention is not limited to the use of the stator core 232 formed of 24 split cores. The present invention is applicable to the stator core 232 as far as it is divided into two or more split cores. The number of split cores may be smaller than 24 and larger than 24. Similarly, the number of core plates used to form each split core is not limited to the number used in the foregoing embodiments.

(7) The foregoing embodiments have been described on the assumption that the stator coil 233 is concentratedly wound around the stator core 232. However, the present invention is not limited to the use of such a concentrated winding method. A distributed winding method may alternatively be used to wind the stator coil 233 around the stator core 232.

(8) The foregoing embodiments have been described in relation to the electric rotating machine 200 having the rotor 250 in which the permanent magnets 254 are embedded. However, the present invention is also applicable to an induction motor and other electric rotating machines having the rotor 250 that includes the rotor core 252, a rotor bar formed of a conductive material, and a squirrel-cage winding.

(9) The electric rotating machine according to the present invention can be applied to various electric vehicles such as hybrid electric trains and other electric railroad vehicles, electric buses, electric trucks, and battery-operated forklift trucks and other electric industrial vehicles.

While various embodiments and their modifications have been described above, the present invention is not limited to such embodiments and modifications. Other embodiments that are considered to fall within the range of the technical concept of the present invention are also to be included within the scope of the present invention.

The disclosure of the following priority-based application is incorporated herein as a quote:

Japanese Patent Application No. 2011-179024 (filed on Aug. 18, 2011)

1. An electric rotating machine comprising:
a stator that includes a housing and a cylindrical stator core secured to the housing by shrinkage fitting; and
a rotor that is rotatably disposed inside the stator,
wherein the stator core is formed of two or more circumferentially split cores, and
wherein split surfaces of the split cores are shaped in such a manner that the amount of distortion caused on the split surfaces on the outside diameter side by the shrinkage fitting is greater than the amount of distortion caused on the split surfaces on the inside diameter side by the shrinkage fitting.

2. The electric rotating machine according to claim 1, wherein a convex or concave engagement portion is formed between the split surfaces on the outside diameter side and the split surfaces on the inside diameter side to engage adjacent split cores with each other.

3. The electric rotating machine according to claim 1, wherein the split surfaces on the outside diameter side circumferentially protrude from the split surfaces on the inside diameter side.

4. The electric rotating machine according to claim 1, wherein the split surfaces of the split cores are shaped in such a manner that when the outside diameter side split surface of one split core comes into contact with the outside diameter side split surface of another split core adjacent to the one split core, a gap is formed between the inside diameter side split surface of the one split core and the inside diameter side split surface of the other split core before the housing is shrinkage-fit and the inside diameter side split surface of the one split core comes into contact with the inside diameter side split surface of the other split core after the housing is shrinkage-fit.

5. The electric rotating machine according to claim 1, wherein the inside diameter side split surfaces of the split cores are chamfered in a curved form.

6. The electric rotating machine according to claim 1, wherein the inside diameter side split surfaces of the split cores are chamfered in a linear form.

7. The electric rotating machine according to claim 2, wherein the split surfaces on the outside diameter side circumferentially protrude from the split surfaces on the inside diameter side.

8. The electric rotating machine according to claim 2, wherein the split surfaces of the split cores are shaped in such a manner that when the outside diameter side split surface of one split core comes into contact with the outside diameter side split surface of another split core adjacent to the one split core, a gap is formed between the inside diameter side split surface of the one split core and the inside diameter side split surface of the other split core before the housing is shrinkage-fit and the inside diameter side split surface of the one split core comes into contact with the inside diameter side split surface of the other split core after the housing is shrinkage-fit.

9. The electric rotating machine according to claim 2, wherein the inside diameter side split surfaces of the split cores are chamfered in a curved form.

10. The electric rotating machine according to claim 2, wherein the inside diameter side split surfaces of the split cores are chamfered in a linear form.
